(19) United States
(12) Patent Application Publication
(10) Pub. No.: US 2011/0274483 A1
(43) Pub. Date: Nov. 10, 2011

(54) BOLTED JOINT ASSEMBLY

(75) Inventors: Dragan Stojkov, Southgate, MI (US); Shawn Morgans, Chelsea, MI (US); Mike Freeman, Allen Park, MI (US)

(73) Assignee: FORD GLOBAL TECHNOLOGIES, LLC, DEARBORN, MI (US)

(21) Appl. No.: 12/776,359

(22) Filed: May 7, 2010

(51) Int. Cl. F16B 7/18

(52) U.S. Cl. 403/196

(57) ABSTRACT

A bolted joint assembly is described. The joint assembly includes a tubular reinforcement member for adding strength to the anchor assembly. The member having an aperture punched through-and-through the member substantially perpendicular to the longitudinal axis of the member. The anchor assembly further includes a hollow spacer tube extending through the aperture, the spacer diameter being substantially equal to the aperture diameter. Moreover, the assembly includes a bolt with a bolt head extended through the spacer. The bolt diameter is substantially equal to the spacer diameter. A nut threadably receives the anchor bolt.

### BACKGROUND OF THE INVENTION

The present application relates generally to joint assemblies, and more particularly, to hydroformed reinforced joint assemblies.

Typical bolted joints in automotive applications, such as seat belt anchorage, seat anchorage, and structural component mounts, are required to handle high loads. For example, legal standards in certain jurisdictions require seatbelt anchor bolts to support a load, sufficient to ensure that they do not fail in the event of a sudden large force, imposed, for example, by emergency braking or an accident.

Generally, for such anchor applications, a nut-bolt joint assembly is utilized. For example, in a seatbelt application, the bolt is generally secured to a structural panel of the vehicle side pillar, threaded into an anchor nut. In high impact situations, excessive loads may be asserted on this joint assembly causing a “peel stress” on the nut-bolt assembly, which in turn can loosen the joint or cause catastrophic joint failure. Further, these structures experience torque losses due to the large bearing surfaces exposed to stresses.

As a result, there exists a need for an improved bolted joint assembly that combines high strength, good manufacturability, and low cost.

### BRIEF DESCRIPTION OF THE INVENTION

One embodiment of the present disclosure describes an anchor assembly comprising a tubular reinforcement including an aperture punched through-and through the member substantially perpendicular to the longitudinal axis of the member. The assembly further includes a hollow spacer tube extending through the aperture of the reinforcement member; the spacer diameter is substantially equal to the aperture diameter. Moreover, the assembly includes an anchor bolt having a bolt head extending through the spacer, the bolt diameter being substantially equal to the spacer diameter, and a nut threadably receiving the anchor bolt.

Embodiments of the present disclosure provide many advantages. For example, the reinforcement member may be hydroformed, which provides high strength to the anchor assembly. Further, the joint includes a bearing surface on a single metal (the nut surface); therefore, the joint does not introduce any torque loss. Further, the nut design compensates localized stresses at the threaded joint bearing surfaces. This reduces the peel force, and the joint is subjected mostly to shear stress. Moreover, the joint assembly is inexpensive and can be formed of any suitable material without departing from the scope of the present disclosure.

These and other advantages, features, and objects of the present application will become apparent upon review of the following detailed description of the preferred embodiments when taken in conjunction with the drawings and the appended claims.

### BRIEF DESCRIPTION OF THE DRAWINGS

FIG. 1 is an exploded view of a joint assembly according to an embodiment of the present disclosure.

FIG. 2 is a schematic cross-sectional plan view of the joint assembly, taken on plane X-X′ of FIG. 1.

### DETAILED DESCRIPTION OF THE INVENTION

Although the best mode for carrying out the invention has been described in detail, those familiar with the art to which this invention relates will recognize various alternative designs and embodiments for practicing the invention as described by the claims.

Embodiments of the present disclosure are directed towards an anchor assembly including a tubular reinforcement member. A nut-bolt assembly is fastened through the reinforcement member to increase the strength of the anchor assembly, reduce torque losses, and to reduce peeling stresses on the bolt.

In typical nut-bolt assemblies, joint failure requires a threshold force sufficient only to pull the bolt through the nut. The present disclosure, however, provides a design that can withstand a considerably higher threshold force, as the bolt is fastened through a reinforcement member; in this design, failure can only be realized if the applied force (from a collision, for example) is sufficient to force the bolt through the reinforcement member and the nut. Further, the assembly includes a hollow spacer or sleeve inserted between the bolt and an aperture in the reinforcement member to reduce bearing joint surfaces, thereby reducing bearing stresses, and in turn reducing torque loss.

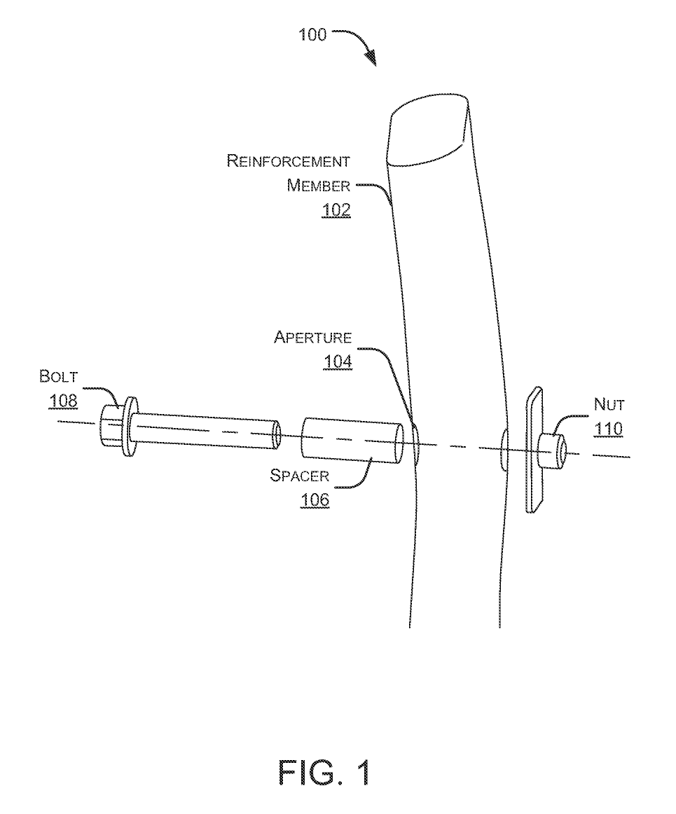

FIG. 1 is an exploded view of an embodiment of an anchor assembly 100 according to the present disclosure. The anchor assembly 100 includes a tubular reinforcement member 102 having an aperture 104 punched through-and-through the member 102 substantially perpendicular to the longitudinal axis. The reinforcement member 102 adds strength to the anchor assembly 100. The assembly 100 further includes a hollow spacer tube 106 extending along a longitudinal axis through the aperture 104 of the reinforcement member 102; the spacer 106 diameter being substantially equal to the aperture 104 diameter.

Further, an anchor bolt 108 having a bolt head extends through the spacer 106, the diameter of the anchor bolt 108 being substantially equal to the diameter of the spacer 106. A nut 110 threadably receives the anchor bolt 108 through the reinforcement member 102 for fastening the bolt 108. Bolting through-and-through, the reinforcement member 102 minimizes torque losses and substantially increases the clamp load and the strength of the bolt 108 as any force applied on the bolt 108 is spread across the surface of the reinforcement member 102. In addition, this design reduces any peeling stresses applied on the anchor's bearing surface; this is because, the bolt length (in the aperture of the reinforcement member) leverages mechanical advantage (acting as a lever arm). Moreover, the nut 110 may be welded on the surface of the reinforcement member 102 where it threadably receives the bolt 108, thereby increasing the strength of the anchor assembly 100 even more and enabling the bolt 108 to withstand very high loads or sudden impact.

The anchor assembly 100 described here may be utilized for a number of automobile applications that require high strength joints, such as seat-belt anchorage, seat anchorage, sub-frame mounting, battery mounting, and so on. Further, the anchor assembly 100 may be utilized in non-automotive applications as well, such as aircrafts, railways, turbines, and any other high-strength applications.

The tubular reinforcement member 102 may be manufactured using any known hydroforming techniques, such as tube hydroforming. In tube hydroforming, pressure is applied to the inner surface of a tube that is held by dies with the desired cross sections and forms. When the dies are closed, the tube ends are sealed by axial punches and the tube is filled with hydraulic fluid. The applied internal pressure causes the tube to expand until it matches the die form. The fluid is injected into the tube through one of the two axial punches. Axial punches are movable and their action is required to provide axial compression and to feed material towards the center of the tube. Transverse counterpunches may also be incorporated in the forming die in order to form protrusions with small diameter/length ratio. Transverse counterpunches may also be used to punch holes in the work piece at the end of the forming process. Two types of hydroforming processes may be utilized—high pressure or low-pressure tube hydroforming (THF). In the high-pressure process, a tube is fully enclosed in a die prior to application of the hydraulic force. In the low-pressure process, the tube is slightly pressurized to a fixed volume during the closing of the die.

Further, the tubular reinforcement member 102 can have any shape, such as a rectangular cross-section, circular cross-section, or a polygonal cross-section without departing from the scope of the present disclosure. Hydroformed tubes are preferred as they are cost-effective, lightweight, structurally stiff, and strong pieces that can withstand high loads or pressures. It will be understood, however, that the tubular reinforcement member 102 may be formed of any other technique known in the art, such as welding, roll-forming, or solid die stamping without departing from the scope of the present disclosure.

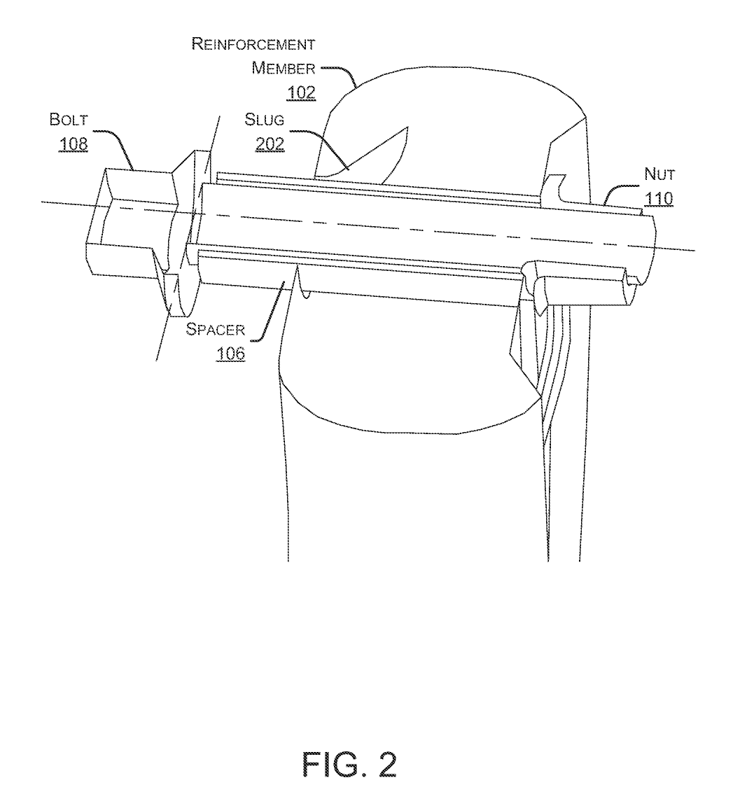

FIG. 2 is a schematic cross-sectional plan view of the anchor assembly 100, taken on plane X-X′ of FIG. 1. This view clearly illustrates the aperture 104, which is punched through the tubular reinforcement member 102 to insert the hollow spacer 106 and the bolt 108. Methods for producing the aperture 104 include drilling/milling, laser or plasma cutting, flow drilling, and hydropiercing, or post-piercing. One economical technique to produce the aperture 104 in a hydroformed tube is to punch a hole in the hydroforming die during the forming cycle. Alternatively, hydropiercing can be used to produce various aperture 104 styles. For example, an aperture 104 can be punched in the reinforcement member 102 that pierces a small pilot hole and urges material into the hole to form an extrusion. This method provides a lead-in and a longer land for better self-threading fastener engagement.

Other techniques to create apertures that are typically performed after hydroforming may be utilized during the hydroforming process to minimize part cost, but each situation is reviewed separately to assess feasibility. The present disclosure does not limit the size the shape of the through-hole and any different aperture shape can be contemplated, including round, oval, rectangular, or hexagonal without departing from the scope of the present disclosure.

As described, a number of techniques may be utilized to create the through-hole. According to some techniques, a slug 202 (the remnants of the reinforcement member 102 that is punched-in for forming the hole) is held captive within the reinforcement member 102 by a feature on one side of the punch, which ensures that a portion of one side of the slug 202 remains attached to the reinforcement member 102. The slug 202 is folded back about this portion, into the interior of the reinforcement member 102, by the movement of the punch during the punch operation, and is held captive by this portion without obscuring the opening of the aperture 104. As the captive slug 202 doubles-up the reinforcement member 102 in the high stress area (shown in FIG. 2) between the anchor bolt 108 and the aperture 104, it further improves the load bearing capacity of the hydroform. Another technique bends the slug 202 into the reinforcement member 102. In this technique, the slug 202 is not folded back into the interior of the reinforcement member 102; instead, the slug 202 is slightly bent. Other techniques may completely remove the slug 202 from the reinforcement member 102 after punching the hole.

The hollow spacer 106 is inserted in the through-hole of the tubular reinforcement member 102, while the bolt 108 is inserted in the hollow spacer 106. The spacer 106, providing a single metal thickness, increases the clamp load on the surface that has the nut 110, thereby decreasing, or eliminating torque losses. Further, the spacer 106 increases the strength of the anchor assembly 100. The bolt 108 extends through the tubular reinforcement member 102 to the other side. Here, the nut 110 fastens the bolt 108 to the reinforcement member 102. In seat belt applications, this anchor assembly 100 is fastened to a side pillar of the vehicle, near the passenger's head. In seat anchorage situations, the anchor assembly 100 may be bolted to the vehicle floor. As the bolt 108 extends through the reinforcement member 102, the load bearing capacity of the bolt 108 is increased. Further, any load or stress applied to the bolt 108 is extended over the length of the reinforcement member 102, thereby distributing the load uniformly across the member 102, further increasing the bolt strength.

The bolt 108 may be selected from any known fastening means, such as M8, M10, M12 bolts, weld studs, deep-shanked spin nuts, or any other form of bolts. The nut 110 may be a spin nut or an extruded nut, among types. Moreover, the bolt 108 may be projection welded to the nut 110, pierce fastened to the nut 110, or welded. It will be understood that other fastening means are contemplated and are well within the scope of the present disclosure.

Due to the through-bolt structure and the spacer 106, the bearing surface of the anchor assembly 100 is on a single metal (the nut surface), which reduces or eliminates torque losses in the anchor assembly 100.

The embodiments of the present disclosure described herein provide a reinforced anchor assembly 100 capable of withstanding very high loads. The anchor assembly 100 may be used in any application that requires high strength joints, such as seatbelt anchorage, seat anchorage, sub-frame mounting, and so on.

1. An anchor assembly comprising:
a tubular reinforcement member with an aperture punched through-and-through the member substantially perpendicular to the longitudinal axis of the member;
a hollow spacer tube extending through the aperture, the spacer diameter being substantially equal to the aperture diameter;
an anchor bolt, having a bolt head, extending through the hollow spacer, the bolt diameter being substantially equal to the spacer diameter; and
a nut threadably receiving the anchor bolt.

2. The anchor assembly of claim 1, wherein the tubular reinforcement member is hydroformed.

3. The anchor assembly of claim 2, wherein the reinforcement member includes a captive slug.

4. The anchor assembly of claim 2, wherein the reinforcement member has a rectangular cross-section.

5. The anchor assembly of claim 2, wherein the reinforcement member cross-section is circular, polygonal, or irregular in shape.

6. The anchor assembly of claim 1, wherein the anchor bolt is a weld stud.

7. The anchor assembly of claim 1, wherein the anchor bolt is a deep-shanked spin-nut.

8. The anchor assembly of claim 1, wherein the anchor bolt is projection welded to the nut.

9. The anchor assembly of claim 1, wherein the anchor bolt is pierce fastened to the nut.

10. The anchor assembly of claim 1, wherein the anchor bolt is welded to the nut or the spacer tube.

11. The anchor assembly of claim 1, wherein the nut is welded to the surface of the reinforcement member substantially around the aperture.

12. The anchor assembly of claim 1, wherein the nut is a spin nut.

13. The anchor assembly of claim 1, wherein the nut is an extruded nut.

14. The anchor assembly of claim 1 is used for automobile seat-belt anchorage.

15. The anchor assembly of claim 1 is used for automobile seat anchorage.

16. The anchor assembly of claim 1 is used for automobile sub-frame mounting.

17. The anchor assembly of claim 1 is used for automobile battery tray mounting.

18. A side-pillar anchor fastener for a vehicle seatbelt, the fastener comprising:
a tubular hydroformed reinforcement member with an aperture punched through-and-through the member substantially perpendicular to the longitudinal axis of the member;
a hollow spacer tube extending through the aperture, the spacer diameter is substantially equal to the aperture diameter;
an anchor bolt having a bolt head extending toward the hollow spacer, the bolt diameter being substantially equal to the spacer diameter; and
a nut welded to the outer surface of a second opening of the through-hole for threadably receiving the anchor bolt and fastening the anchor bolt to the side-pillar of the vehicle.

19. The side-pillar anchor fastener of claim 18, wherein the anchor bolt is at least one of a M8 bolt, M10 bolt, M12 bolt, deep-shanked bolt, or weld stud.

20. The side-pillar anchor fastener of claim 18, wherein the nut is at least one of a spin nut or an extruded nut.
